(19) United States
(12) Patent Application Publication
(10) Pub. No.: US 2007/0259167 A1
(43) Pub. Date: Nov. 8, 2007

(54) Wood/plastic composites with glass fiber reinforcement

(76) Inventor: Ghaus M. Rizvi, Oshawa (CA)

Correspondence Address: Ralph A. Dowell of DOWELL & DOWELL P.C., 2111 Eisenhower Ave, Suite 406, Alexandria, VA, 22314, US

(21) Appl. No.: 11/797,655

(22) Filed: May 4, 2007

Related U.S. Application Data
(60) Provisional application No. 60/797,683, filed on May 5, 2006.

(51) Int. Cl. B32B 17/02; B32B 27/04

(52) U.S. Cl. 428/300.4; 428/299.4

(57) ABSTRACT

A method for producing natural fiber composite materials, which increases the flexural strength, thereby, making them more suitable for load bearing applications. The composite material mainly consists of natural cellulose fibers, preferably wood fibers, and olefin group of plastics and is in addition reinforced by a small amount of glass fibers which increases the flexural strength making it suitable for structural applications. A coupling agent, which increases bonding between both glass and natural fibers, with the olefin matrix is also used. The composite material can also be foamed to reduce density & cost and improve toughness, ability to accept screws/nails and surface texture.

### CROSS REFERENCE TO RELATED PATENT APPLICATION

This patent application relates to U.S. Provisional Patent Application Ser. No. 60/797,683 filed on May 5, 2006 entitled WOOD/PLASTIC COMPOSITES WITH GLASS FIBER REINFORCEMENT which is incorporated herein by reference in its entirety.

### FIELD OF THE INVENTION

This invention relates wood plastic composites and in particular wood plastic composites that use glass fibre reinforcing.

### BACKGROUND OF THE INVENTION

The increasing use of wood is causing erosion of forest resources which is detrimental to the future outlook of global environment. It is imperative for the well being of human race that this trend be stopped by developing acceptable wood replacement alternates. Although reconstituted wood products (pressboard, chipboard, etc.) have been made with thermosetting resins for many years, only in the last two decades, has a serious attempt been made to incorporate cellulose fibers in thermoplastic resins to produce Wood plastic composites (WPC)¹. New compounding techniques and interfacial treatments, utilizing coupling agents, make it feasible to disperse high volume fractions of hydrophilic wood fibers in various plastics. These compounds can be continuously extruded, thermoformed, pressed, and injection molded into any shape and size, and thereby offer the potential to replace natural wood in many applications¹⁻⁴.

The WPC offer many advantages over natural wood. They do not warp, expand or shrink; they are weather, fungus and termite resistant and require very little maintenance. Moreover, not only can they be recycled, but they can also be made entirely from recycled materials. Therefore, the market for these composites is growing at a phenomenal rate so that their market share doubled between 2000 and 2005⁵. But these composites suffer from the disadvantage of being heavier in weight and lower in toughness compared to wood, which makes them unsuitable for many applications²⁻⁴. Both of these properties can be improved by incorporating a foam structure in these composites^{1,6}. Foamed WPC are tougher, lighter, feel more like real wood, are more economical, and also accept screws and nails, more like real wood than do their un-foamed counterparts¹.

Over the last few years, a number of such foamed WPC have been commercially made available. However, foaming leads to poor flexural strength and creep deformation⁶, which severely limits the scope of their applications. Therefore, a great deal of improvement in properties is required before they can have a significant impact on new wood usage. The mechanical properties of plastics can be significantly increased by using glass fiber reinforcements in a plastic matrix⁷. Therefore, assuming that this method of increasing the mechanical properties will also be effective in hybrid form of glass fibers and WPC, this work was undertaken to demonstrate the effectiveness of producing WPC with inclusions of glass fiber reinforcements (GFR) and thereby improving the mechanical properties. Very few examples of GFR/natural fiber hybrid composites were found in literature. Jiang etal⁸ and Maldas⁹ etal studied PVC based WPC with GF and found improvement in properties. John etal¹⁰ studied resin based WPC and noted improvement in flexural strength when GF reinforcement is used. Kitano etal¹¹ studied the effects of long and short GF, along with other fibers, on properties of HDPE (high density polyethylene) based composites containing 20 vol % fibers. They found that tensile strength decreased on increasing the fiber content when long fibers were used, whereas, the short fibers did not exhibit this pattern. They did not use any coupling agent. No literature could be found on foamed WPC reinforced with GF.

Accordingly it would be advantageous to provide a wood plastic composite that uses glass fiber reinforcement to increase the strength and modulus of the product.

### SUMMARY OF THE INVENTION

The invention is a composite material having a foam structure comprising: a plastic matrix; cellulose fibre filler; and glass fibre filler.

A further aspect of the invention is a composite material comprising: a plastic matrix; cellulose fibre filler; glass fibre filler; and a coupling agent which bonds the cellulose fibre filler and the glass fibre filler to the plastic matrix.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a graph that shows the effect on stress, at fracture of adding glass fibre to wood plastic composite;

FIG. 2 is a graph that shows the effect on elongation at fracture of adding glass fibre to wood plastic composite;

FIG. 3 is a graph that shows the effect on secant modules of composites of adding glass fibre to wood plastic composite;

FIG. 4 is graph that shows the effect on density of composites of adding glass fibre to wood plastic composite;

FIG. 5a is a microstructure of fracture surface of wood plastic composite specimen container 30% wood fibre; and

FIG. 5b is a microstructure of fracture, surface of wood plastic composite specimen containing 30% wood fibre and 5% glass fibre.

### DETAILED DESCRIPTION OF THE INVENTION

One aspect of the invention is a method for producing plastic/natural fiber composite structures which are reinforced with smaller amounts of glass fibers (preferably less than 15% by weight) and the formulation includes a coupling agent such as one based on maleic anhydride, which acts as a bonding agent for both the natural cellulosic fibers and the glass fibers with the plastic matrix. This material can be produced by using any of the standard techniques for producing these composites, including extrusion, injection molding, compression molding etc. In one embodiment of the invention the plastic is a thermoplastic composite. In another embodiment of the invention the plastic is chosen from the olefin group of plastics. In a further embodiment of the invention the plastic is a high density polyethylene.

Another aspect of the invention is a method for producing plastic/natural fiber composite with a cellular structure which is reinforced with smaller amounts of glass fibers and the formulation includes a coupling agent such as one based on maleic anhydride, which acts as a bonding agent for both the natural cellulosic fibers and the glass fibers with the plastic matrix. This material can be produced by using any of the standard techniques for producing these composites in extrusion or injection molding. The preferred method of producing these composites in extrusion is described in U.S. Pat. No. 6,936,200. In one embodiment of the invention the plastic is a thermoplastic composite. In another embodiment of the invention the plastic is chosen from the olefin group of plastics. In a further embodiment of the invention the plastic is a high density polyethylene.

The invention herein is a wood plastic composite that includes glass fibre as filler. The glass fibre is preferably less than 15% by weight. Preferably the plastic is a thermoplastic composite and more specifically preferably the plastic is chosen from the group of olefin plastics. Preferably the cellulosic filler is between 10% and 60% by weight of the material.

The invention herein is described below by way of example only. The plastic material used in this study was HDPE (2710, MI=17, Nova Chemical), and the WF used was standard softwood (pine) grade 12020, supplied by American Wood Fibers. The coupling agent used for improving the adhesion between the hydrophobic HDPE and the hydrophilic WF was the maleic anhydride-g-HDPE (MAH-g-PE, Fusabond MB-100D, 0.8˜1.1 wt % of MAH, MI 0.2.0 g/10 min, DuPont Canada) and in all compositions it was 3 wt % of mixed HDPE and WF. The glass-fiber (GF) used was Owens Corning Milled Fiber, 737-BD, 1/32″ in length and 16 micron diameter. The coupling agent used also improved adhesion between plastic and GF.

Experimental

Preparation of Samples: HDPE, WF and the coupling agent were mixed in a kinetic mixer from Werner & Pfleiderer till the temperature rose to 180° C. and allowed to cool down. It was then granulated using a C.W. Brabender granulator into small pellets, which were then oven dried, overnight, under a vacuum using an Advantec-Vacuum drying oven at a temperature of 80° C. The mixture was then extruded in C.W. Brabender extrusion system and pelletized in a C.W. Brabender pelletizer. In the case of HDPE-WF/GF composite, the milled GF were added and mixed with the oven-dried mixture before being extruded and pelletized.

Compression Molding: The pellets were then compression-molded into sheets using a Carver Hydraulic press. The mold was compressed at 160° C. under 4.5 metric tons for one minute. After forming, the sheets where cooled, under pressure, to ambient temperature and cut into dog-bone shaped sample conforming to ASTM D638 type-V specifications.

Mechanical Property Testing: The dog-bone shaped samples cut from the compression-molded sheets were tested on a LLOYD Instruments LS100 Universal Testing Machine, till fracture, according to ASTM D638, but with the cross-head speed of 1 mm/min, and the results were obtained using NEXYGEN MT software. For each composition 10 samples were tested and the average values were used for interpreting the results.

Density: The densities of the samples were determined using ASTM D792-00.

Scanning Electron Microscope (SEM) Characterization of fracture surface: The samples were cut near the fracture surface and SEM micrographs of fracture surfaces were taken. For this, each sample was first gold-coated, using a sputter coater (E 50000C PS3), and the microstructure was examined using a Hitachi 510 SEM.

Results and Discussion

Effect of GF on stress at fracture: One advantage of using the maleic anhydride as a coupling agent is that it promotes adhesion between plastic and both WF and GF so that only one coupling agent can be used for both materials. FIG. 1 shows the result of adding 5% GFR in WPC. As expected the fracture strength of WPC increased from 16 to 31% for different compositions of WPC, due to the addition of GFR. The strong GF did contribute to increasing the load bearing ability of the WPC. This also indicates that maleic-ahydride coupling agent successfully promoted adhesion between GF and the plastic matrix.

Effect of WF content on stress at fracture: FIG. 1 also shows the effect of WF content on the stress level at which fracture occurs in WPC and WPC+5% GFR samples. The WPC did not exhibit any remarkable change in fracture stress levels with varying WF contents. However, when 5% GF was added, not only did the fracture stress level increased in general, but it also increased with increasing WF content, increasing from 16% compared to WPC when WF content was 10%, to 31% compared to WPC when the WF content was 300%. This result is somewhat surprising.

In all compositions, the coupling agent constituted 3 parts per 100 parts of mixture by weight. Therefore, one possible explanation for the observed behavior is that with increasing WF content, the concentration of coupling agent in the plastic matrix increased, as it would not be dissolved in the solid wood particles. This increased concentration of coupling agent in the plastic matrix resulted in improvement in adhesion between the GF and the plastic matrix resulting in higher mechanical properties.

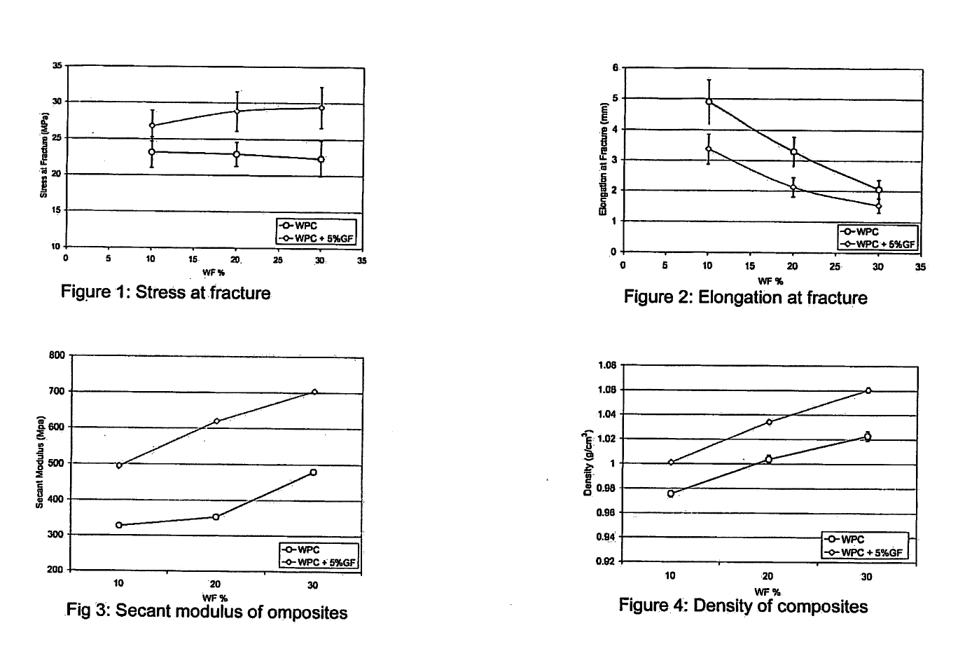

Effect of WF and GF content on elongation at fracture: FIG. 2 shows these effects clearly. Addition of GF decreases the elongation at fracture due to the increased stiffness provided by these fibers. Increasing the WF content also reduces the elongation at failure due to reduction in the amount of ductile plastic matrix in the composite.

Effect of WF and GF content on modulus: FIG. 3 shows the secant modulus of WPC and GFR-WPC. The modulus increases with increasing WF contents for all composites. However, the inclusion of GF resulted in the very significant increase of about 50% in the value of the modulus. This is directly due to the high value of the reinforcing material's modulus.

Effect of WF and GF content on density: FIG. 4 shows the density of the composites. Addition of GF increased the density of the composite by about 2 to 3%. Increasing the WF composition by 10% also resulted in similar amount of density increases.

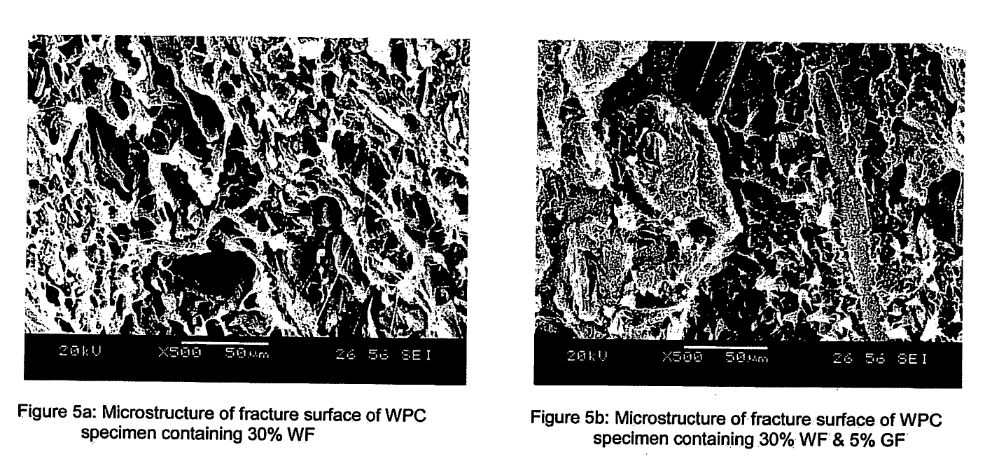

Microstructure of the fracture surfaces: FIG. 5 show the SEM micrographs of xx % WPC and WPC+5% GF. In the WPC with GF, the glass fiber can be seen clearly and apparently the coupling agent has not fully acted on the glass surface as adhesion is not observed. Whereas, the WF are not distinguishable indicating that the amount of coupling agent used is sufficient for fully compatibilizing the WF but not the GF. Additional work is needed to clarify the amount of coupling agent required for full compatibilization of GF.

### CONCLUSION

The inclusion of 5% GF reinforcement resulted in substantial improvements in both strength and modulus of WPC. However, inspection of SEM micrographs indicates that perhaps the GF have not achieved full adhesion with the plastic matrix and there may be room for further improvement in properties.

In this study, tensile tests of WPC specimen with and without GFR were carried out for varying amounts of WF content. Density and surface characteristics of the fractured specimen were also studied. Significant improvements in properties were observed.

A common problem in production of natural fiber composites is the control of volatiles emitted by the cellulosic fibers at the elevated processing temperatures. In normal composites, the volatile emissions can cause unwanted voids which can severely hamper the mechanical properties of the composites. In foamed composites, these volatiles can deteriorate the cell structure of the obtained foams, leading to poor mechanical properties. One way of alleviating this problem is to pre-dry the cellulosic natural fibers by using one of the standard drying techniques and limiting the duration and temperature of the process to a low value as taught by the U.S. Pat. No. 6,936,200 issued Aug. 30, 2005 to Park et al.

The invention herein is related to the use of glass fibre filler with wood plastic composite foams. As well the invention herein has determined that the use of a coupling agent, or a blend of coupling agents, that is compatible with both the wood filler and glass fibre filler improves the properties of the wood plastic composite.

As used herein, the terms “comprises” and “comprising” are to construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

It will be appreciated that the above description related to the invention by way of example only. Many variations on the invention will be obvious to those skilled in the art and such obvious variations are within the scope of the invention as described herein whether or not expressly described.

### REFERENCES

1 J. H. Schut, Plastic Technology, March (1999).
2 C. Clemons, Forest Products J, 54, 6, 10 (2002).
3 R. G. Raj, B V Kokta, J D Nizio, J Appl Polym Sci, 45, 91, (1992).
4 R. G. Raj, B. V. Kokta, G. Groleau, and C. Daneault, Plast. Rubber Proc. Appl., 11, 215 (1989).
5 http://www.principiaconsulting.com/publishing/news.cfm?article=56
6 F. A. Shutov, in Handbook of Polymeric Foams and Foam Technology, D. Klempner and K. C. Frisch, eds., Hanser, New York (1991)
7 N. P. Cheremisinoff, P. N. Cheremisinoff, Fiberglass Reinforced Plastics, ©1995 Noyes
8 H. Jiang, D. P. Kamden, B. Bezubic and P. Ruede, J Vinyl & Add Technol, 9, 3, 138-145 (2003)
9 D. Maldas and B. V. Kokta, Intern. J Polymeric Mater. 17, 205-214 (1992).
10 K. John and S. V. Naidu, J. Reinf. Plastics and Comp., 23, 15, 1601 (2004).
11 T. Kitano, E. Haghani, T Tanegashima and P. Saha, Polym Comp, 21, 4, 493-505 (2000)

What is claimed as the invention is:

1. A composite material having a foam structure comprising:
a plastic matrix;
cellulose fibre filler; and
glass fibre filler.

2. A composite material as claimed in claim 1 wherein the plastic is a thermoplastic composite.

3. A composite material as claimed in claim 1 wherein the plastic is chosen from the olefin group of plastics.

4. A composite material as claimed in claim 1 wherein the plastic is high density polyethylene.

5. A composite material as claimed in claim 2 wherein the cellulose fibres are chosen from a group consisting of wood, hemp, jute, rice hull, flax and a combination thereof.

6. A composite material as claimed in claim 5 further including a coupling agent, or a blend of coupling agents, which acts on both the cellulose fibre filler and the glass fibre filler to couple each to the plastic matrix.

7. A composite material as claimed in claim 6 wherein the cellulose fibre filler is wood fibers.

8. A composite material as claimed in claim 7 wherein the composite material is manufactured from one of extrusion, injection molding and compression molding.

9. A composite material as claimed in claim 7 wherein the composite material is manufactured by extrusion processing and the largest cells are smaller than 100 micrometers.

10. A composite material as claimed in claim 7 wherein the composite material is manufactured by injection molding and the largest cells are smaller than 100 micrometers.

11. A composite material as claimed in claim 7 wherein the cellulosic filler is between 10% and 60% by weight of the material.

12. A composite material as claimed in claim 11 wherein the cellulosic fibre filler is between 30% and 50% by weight of the material.

13. A composite as claimed in any one of claims 12 wherein the glass fibre filler is between 1% to 15% by weight of the material.

14. A composite material as claimed in any one of claims 3 wherein the cellulose fibres are chosen from a group consisting of wood, hemp, jute, rice hull, flax and a combination thereof.

15. A composite material as claimed in any one of claims 14 further including a coupling agent, or a blend of coupling agents, which acts on both the cellulose fibre filler and the glass fibre filler to couple each to the plastic matrix.

16. A composite material as claimed in any one claims 15 wherein the cellulose fibre filler is wood fibers.

17. A composite material as claimed in any one of claims 16 wherein the composite material is manufactured from one of extrusion, injection molding and compression molding.

18. A composite material as claimed in any one of claims 16 wherein the composite material is manufactured by extrusion processing and the largest cells are smaller than 100 micrometers.

19. A composite material as claimed in any one of claims 16 wherein the composite material is manufactured by injection molding and the largest cells are smaller than 100 micrometers.

20. A composite material as claimed in any one of claims 16 wherein the cellulosic filler is between 10% and 60% by weight of the material.

21. A composite material as claimed in claim 20 wherein the cellulosic fibre filler is between 30% and 50% by weight of the material.

22. A composite as claimed in any one of claims 21 wherein the glass fibre filler is between 1% to 15% by weight of the material.

23. A composite material as claimed in claim 1 further including a coupling agent, or a blend of coupling agents, which acts with the cellulose fibre filler and the glass fibre filler to couple each with the plastic matrix.

24. A composite material as claimed in claim 23 wherein the plastic is a thermoplastic composite.

25. A composite material as claimed in claim 23 wherein the plastic is chosen from the group of olefin plastics.

26. A composite material as claimed in claim 23 wherein the plastic is high density polyethylene.

27. A composite as claimed in any one of claims 24 wherein the cellulose fibres are chosen from a group consisting of wood, hemp, jute, rice hull, flax and a combination thereof.

28. A composite material as claimed in any one of claims 27 further including a coupling agent, or a blend of coupling agents, which acts on both the cellulose fibre filler and the glass fibre filler to couple each to the plastic matrix.

29. A composite material as claimed in any one claims 28 wherein the cellulose fibre filler is wood fibers.

30. A composite material as claimed in any one of claims 29 wherein the composite material is manufactured from one of extrusion, injection molding and compression molding.

31. A composite material as claimed in any one of claims 29 wherein the cellulosic filler is between 20% and 60% by weight of the material.

32. A composite material as claimed in claim 31 wherein the cellulosic fibre filler is between 30% and 50% by weight of the material.

33. A composite as claimed in any one of claims 31 wherein the glass fibre filler is between 1% to 15% by weight of the material.

34. A composite as claimed in any one of claims 33 wherein the coupling agent is a maleic anhydride based coupling agent.

35. A composite as claimed in any one of claims 25 wherein the cellulose fibres are chosen from a group consisting of wood, hemp, jute, rice hull, flax and a combination thereof.

36. A composite material as claimed in any one of claims 35 further including a coupling agent, or a blend of coupling agents, which acts on both the cellulose fibre filler and the glass fibre filler.

37. A composite material as claimed in any one claims 36 wherein the cellulose fibre filler is wood fibers.

38. A composite material as claimed in any one of claims 37 wherein the composite material is manufactured from one of extrusion, injection molding and compression molding.

39. A composite material as claimed in any one of claims 38 wherein the cellulosic filler is between 10% and 60% by weight of the material.

40. A composite material as claimed in claim 38 wherein the cellulosic fibre filler is between 30% and 50% by weight of the material.

41. A composite as claimed in any one of claims 38 wherein the glass fibre filler is between 1% to 15% by weight of the material.

42. A composite as claimed in any one of claims 41 wherein the coupling agent is a maleic anhydride based coupling agent.
